(19) United States
(12) Patent Application Publication
(10) Pub. No.: US 2017/0147558 A1
(43) Pub. Date: May 25, 2017

(54) APPARATUS AND METHOD FOR MULTILINGUAL INTERPRETATION AND TRANSLATION HAVING AUTOMATIC LANGUAGE SETTING FUNCTION

(71) Applicant: ELECTRONICS AND TELECOMMUNICATIONS RESEARCH INSTITUTE, Daejeon (KR)

(72) Inventors: Jeong Se KIM, Daejeon (KR); Sang Hun KIM, Daejeon (KR); Seung YUN, Daejeon (KR)

(21) Appl. No.: 15/192,055

(22) Filed: Jun. 24, 2016

(30) Foreign Application Priority Data
Nov. 24, 2015 (KR) 10-2015-0164884

(51) Int. Cl. G06F 17/28; H04M 1/725; G06F 17/27

(52) U.S. Cl. CPC G06F 17/289; G06F 17/275; G06F 17/2854; H04M 1/7255

(57) ABSTRACT

Provided is a method for interpretation and translation accomplished by an interpretation and translation apparatus of a user through interfacing with an interpretation and translation apparatus of the other party. The method includes: automatically setting a translation target language which enables to communicate with the other party based on a message from the interpretation and translation apparatus of the other party by using a communication connection in a network; receiving input information of a use language of the user; calling a translator corresponding to the translation target language to transmit a result obtained by translating the input information into the translation target language to the interpretation and translation apparatus of the other party; and outputting received data from the interpretation and translation apparatus of the other party or outputting the result obtained by translating the received data into the use language of the user by using the translator.

### CROSS-REFERENCE TO RELATED APPLICATION

This application claims the benefit of priority to Korean Patent Application No. 10-2015-0164884, filed on Nov. 24, 2015 in the Korean Intellectual Property Office, the disclosure of which is incorporated herein in its entirety by reference.

### BACKGROUND OF THE INVENTION

Field of the Invention

The present disclosure relates to an apparatus and a method for multilingual interpretation and translation, and more particularly, to an apparatus and a method for multilingual interpretation and translation capable of performing an automatic interpretation and translation with a preset language using interfacing for automatically checking and setting a language communicable with the other party through a communication with an interpretation and translation of the other party.

Description of the Related Art

Due to the development of voice recognition and machine translation technologies and popular supply of a wireless communication network technology and a smart phone, an automatic interpretation and translation apparatus is widely used in the form of an application of a portable terminal. In general, a user performs automatic interpretation or translation through voice recognition or text input according to a UI configuration of a corresponding application by executing the automatic interpretation and translation apparatus in the portable terminal to obtain a desired result.

However, since the above automatic interpretation and translation apparatus according to the related art may previously select a language communicable with the other party to obtain automatic interpretation and translation results, the user should previously know what is the language of the other party. Further, when the above automatic interpretation and translation apparatus according to the related art does not support a direct interpretation and translation with the language communicable with the other party, a first interpretation and translation apparatus interprets and translates a language of a user into an intermediate language and then a second interpretation and translation apparatus interprets and translates the intermediate language into a language of the other party. That is, interpretation and translation should be manually and inconveniently performed using an interpretation and translation apparatus through multiple steps.

### SUMMARY OF THE INVENTION

The present disclosure has been made in view of the above problems, and provides an apparatus and a method for multilingual interpretation and translation which may automatically check and set a target language for the other party from various options to communicate with the other party using a message exchanged through communication with an interpretation and translation apparatus of the other party, in order to improve convenience for a user by automatically checking and setting a communicable language with the other party to perform automatic interpretation and translation, and may perform automatic interpretation and translation on multilingual voice or text input into a selected target language to provide a result as a voice or a screen.

In accordance with an aspect of the present disclosure, a method for interpretation and translation accomplished by an interpretation and translation apparatus of a user through interfacing with an interpretation and translation apparatus of the other party includes: automatically setting a translation target language which enables to communicate with the other party based on a message from the interpretation and translation apparatus of the other party by using a communication connection in a network; receiving input information of a use language of the user; calling a translator corresponding to the translation target language to transmit a result obtained by translating the input information into the translation target language to the interpretation and translation apparatus of the other party; and outputting received data from the interpretation and translation apparatus of the other party or outputting the result obtained by translating the received data into the use language of the user by using the translator. The input information includes a voice or a text.

Automatically setting a translation target language includes: checking whether a communication with the interpretation and translation apparatus of the other party is connected; generating a language list communicable with the other party according to the message; and setting the translation target language by checking whether a translator, which is suitable for corresponding languages, communicable with the other party is installed therein, according to a preset use language of the user and a use language of the other party checked from the communicable language list.

Setting the translation target language includes setting the translation target language in the communicable language list in a higher order of a translation performance based on a setting reference, and the setting reference is based on information comprising a translation rate of the use language of the user to a target language, a translation rate of the use language of the other party to the target language in the interpretation and translation apparatus of the other party, word order coidentity between the use language of the user and the target language, word order coidentity between the use language of the other party and the target language in the interpretation and translation apparatus of the other party, a language family distance between the use language of the user and the target language in a user side, a language family distance between the use language of the other party and the target language in the other party side, and a user preference.

Automatically setting a translation target language includes setting the translation target language according to a preset order of a plurality of translation methods or setting the translation target language according to a preset order of world languages, among options that have the same translation performance into a target language according to a certain setting reference in the communicable language list.

Automatically setting a translation target language includes: selecting the translation target language to use a translator between the use language of the user and the use language of the other party, translating the input information of the use language of the user into the use language of the other party to transmit to the interpretation and translation apparatus of the other party, by using the translator, and translating and outputting received data of the use language of the other party from the interpretation and translation apparatus of the other party into the use language of the user or outputting received data of the use language of the user from the interpretation and translation apparatus of the other party without translation.

Automatically setting a translation target language includes: selecting the translation target language to use a translator between the use language of the user and an intermediary language, translating the input information of the use language of the user into the intermediary language to transmit to the interpretation and translation apparatus of the other party, by using the translator, and translating and outputting received data of the intermediary language from the interpretation and translation apparatus of the other party into the use language of the user.

Automatically setting a translation target language includes: selecting the translation target language to use a first translator between the use language of the user and an intermediary language and a second translator between the intermediary language and the use language of the other party, sequentially performing translation of the input information of the use language of the user into the intermediary language and translation of the input information into the use language of the other party to transmit to the interpretation and translation apparatus of the other party, by using the first translator and the second translator, and sequentially performing translation of received data of the use language of the other party from the interpretation and translation apparatus of the other party into the intermediary language and translation of received data into the use language of the user to output the translated received data.

Automatically setting a translation target language includes: selecting the translation target language to use a first translator between the use language of the user and a first intermediary language and a second translator between the first intermediary language and a second intermediary language, sequentially performing translation of the input information of the use language of the user into the first intermediary language and translation of the input information into the second intermediary language to transmit to the interpretation and translation apparatus of the other party, by using the first translator and the second translator, and sequentially performing translation of received data of the second intermediary language from the interpretation and translation apparatus of the other party into the first intermediary language and translation of received data into the use language of the user to output the translated received data.

In accordance with another aspect of the present disclosure, an interpretation and translation apparatus of a user through interfacing with an interpretation and translation apparatus of the other party includes: an interpretation and translation interface configured to automatically set a translation target language which enables to communicate with the other party based on a message from the interpretation and translation apparatus of the other party by using a communication connection in a network; an input unit configured to receive input information of a use language of the user; a transmitting unit configured to call a translator corresponding to the translation target language to transmit a result obtained by translating the input information into the translation target language to the interpretation and translation apparatus of the other party; and a reception unit configured to output received data from the interpretation and translation apparatus of the other party or output the result obtained by translating the received data into the use language of the user by using the translator. The input information includes a voice or a text.

The interpretation and translation interface includes: an interpretation and translation possibility checking unit configured to check whether a communication with the interpretation and translation apparatus of the other party is connected; an interpretation and translation language checking unit configured to generate a language list communicable with the other party according to the message; and an automatic interpretation and translation language setting unit configured to set the translation target language by checking whether a translator, which is suitable for corresponding languages, communicable with the other party is installed therein, according to a preset use language of the user and a use language of the other party checked from the communicable language list.

The automatic interpretation and translation language setting unit sets the translation target language in the communicable language list in a higher order of a translation performance based on a setting reference, and the setting reference is based on information comprising a translation rate of the use language of the user to a target language, a translation rate of the use language of the other party to the target language in the interpretation and translation apparatus of the other party, word order coidentity between the use language of the user and the target language, word order coidentity between the use language of the other party and the target language in the interpretation and translation apparatus of the other party, a language family distance between the use language of the user and the target language in a user side, a language family distance between the use language of the other party and the target language in the other party side, and a user preference.

The automatic interpretation and translation language setting unit sets the translation target language according to a preset order of a plurality of translation methods or setting the translation target language according to a preset order of world languages, among options that have the same translation performance into a target language according to a certain setting reference in the communicable language list.

The interpretation and translation interface selects the translation target language to use a translator between the use language of the user and the use language of the other party, translates the input information of the use language of the user into the use language of the other party to transmit to the interpretation and translation apparatus of the other party, by using the translator, and translates and outputs received data of the use language of the other party from the interpretation and translation apparatus of the other party into the use language of the user or outputs received data of the use language of the user from the interpretation and translation apparatus of the other party without translation.

The interpretation and translation interface selects the translation target language to use a translator between the use language of the user and an intermediary language, translates the input information of the use language of the user into the intermediary language to transmit to the interpretation and translation apparatus of the other party, by using the translator, and translates and outputs received data of the intermediary language from the interpretation and translation apparatus of the other party into the use language of the user.

The interpretation and translation interface selects the translation target language to use a first translator between the use language of the user and an intermediary language and a second translator between the intermediary language and the use language of the other party, sequentially performs translation of the input information of the use language of the user into the intermediary language and translation of the input information into the use language of the other party to transmit to the interpretation and translation apparatus of the other party, by using the first translator and the second translator, and sequentially performs translation of received data of the use language of the other party from the interpretation and translation apparatus of the other party into the intermediary language and translation of received data into the use language of the user to output the translated received data.

The interpretation and translation interface selects the translation target language to use a first translator between the use language of the user and a first intermediary language and a second translator between the first intermediary language and a second intermediary language, sequentially performs translation of the input information of the use language of the user into the first intermediary language and translation of the input information into the second intermediary language to transmit to the interpretation and translation apparatus of the other party, by using the first translator and the second translator, and sequentially performs translation of received data of the second intermediary language from the interpretation and translation apparatus of the other party into the first intermediary language and translation of received data into the use language of the user to output the translated received data.

In accordance with the apparatus and the method for multilingual interpretation and translation, a target language for the other party may be automatically checked and set from various options to be able to communicate with the other party using a message exchanged through communication with an interpretation and translation apparatus of the other party, so that automatic interpretation and translation into a selected target language may be performed with respect to the multilingual voice or text input to provide a result as a voice or a screen, thereby providing an interpretation and translation service with an improved convenience for a user.

### BRIEF DESCRIPTION OF THE DRAWINGS

The objects, features and advantages of the present disclosure will be more apparent from the following detailed description in conjunction with the accompanying drawings, in which:

FIG. 1 is a block diagram illustrating a configuration of an apparatus for multilingual interpretation and translation according to an embodiment of the present disclosure;

FIG. 2A is a block diagram illustrating an operation of a transmitting unit shown in FIG. 1;

FIG. 2B is a block diagram illustrating an operation of a receiving unit shown in FIG. 1;

FIG. 3 is a flowchart illustrating an operation of the apparatus for multilingual interpretation and translation according to an embodiment of the present disclosure;

FIG. 4 is a flowchart illustrating receiving and transmitting procedures by options shown in FIG. 3; and

FIG. 5 is a block diagram illustrating an example of implementing the apparatus for multilingual interpretation and translation according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

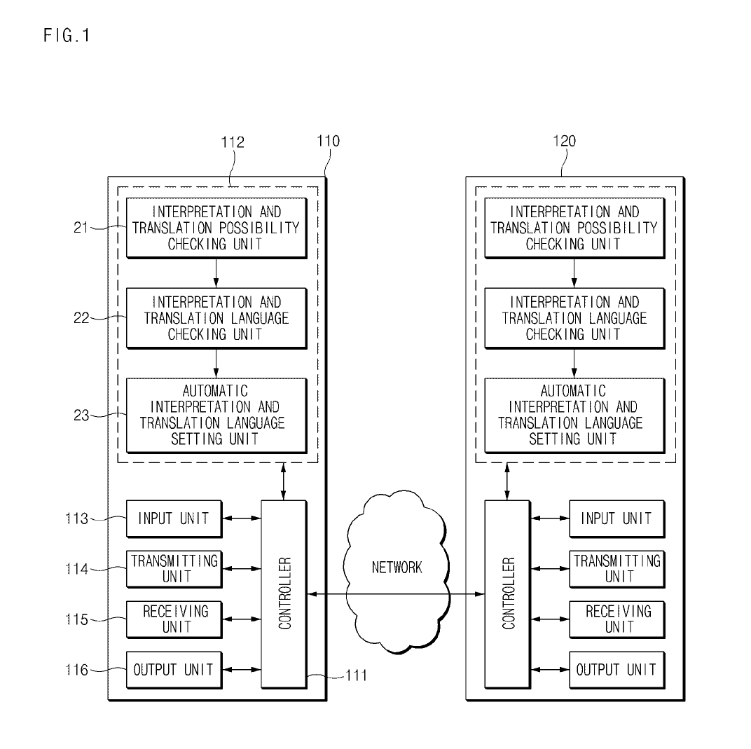

FIG. 1 is a block diagram illustrating a configuration of a multilingual interpretation and translation apparatus 110/120 according to an embodiment of the present disclosure.

Referring to FIG. 1, the multilingual interpretation and translation apparatus 110 and 120 according to an embodiment of the present disclosure may be implemented and installed in a user terminal and a terminal of the other party to have the same or similar configuration.

In this case, the user terminal and the terminal of the other party may be operatively associated with each other through a wired/wireless network for supporting a short range distance wireless communication (e.g., Bluetooth, ZigBee, NFC, and the like), wired Internet communication, wireless Internet communication such as wireless fidelity (Wi-Fi) and WiBro, a mobile communication such as WCDMA, LTE, or a Wireless Access in Vehicular Environment (WAVE) wireless communication. Further, the user terminal and the terminal of the other party may be (wired/wireless) dedicated apparatus which may be operatively associated with each other through the above network. In addition, the user terminal and the terminal of the other party may be various communicable devices including a wired terminal such as a desktop PC, and a wireless terminal such as a smart phone, a tablet PC, a notebook PC, a voice/image phone communicable wearable apparatus.

When a user communicating with the other party inputs voices or texts configured by the user's language, the input voices or texts are translated into a target language which the other part may understand among a multi-language through the multilingual interpretation and translation apparatus 110 of the user. The interpreted and translated voices or texts are transmitted to the multilingual interpretation and translation apparatus 120 of the other party to be output as voices or texts. The other party inputs the voices or texts to the multilingual interpretation and translation apparatus 120 of the other party so that necessary opinion expressions may be transmitted to the user.

In particular, in the present disclosure, the multilingual interpretation and translation apparatus 110 of the user automatically checks and sets a target language for the other part from various options to communicate with the other party using a message exchanged by a communication with the multilingual interpretation and translation apparatus 120 of the other party, and performs automatic interpretation and translation on multilingual voice or text input into a selected target language to provide the result as a voice or a screen, thereby providing an interpretation and translation having improved convenience of the user.

The function of the multilingual interpretation and translation apparatus 110 of the user may be the same as or similar to the function of the multilingual interpretation and translation apparatus 120 of the other party. Accordingly, the following description is made based on the functions of the multilingual interpretation and translation apparatus 110 of the user. However, it is obvious that the function of the multilingual interpretation and translation apparatus 120 of the other party may be equally or similarly implemented.

As shown in FIG. 1, the multilingual interpretation and translation apparatus 110 of the user includes a controller 111, an interpretation and translation interface 112, an input unit 113, a transmitting unit 114, a receiving unit 115, and an output unit 116. Respective constituent elements of the multilingual interpretation and translation apparatus 110 may be configured by hardware such as a semiconductor processor, software such as an application program, and a combination thereof.

The controller 111 controls an overall operation of the above constituent elements in order to perform an automatic interpretation and translation function of the multilingual interpretation and translation apparatus 110. In order to perform the automatic interpretation and translation function, the controller 111 controls an overall function such as the automatic selection of an interpretation and translation language, and the input, the translation and transmission, the reception and translation, and the output of voices or texts according to each option from among various options.

As shown in FIG. 1, the interpretation and translation interface 112 includes an interpretation and translation possibility checking unit 21, an interpretation and translation language checking unit 22, and an automatic interpretation and translation language setting unit 23.

The interpretation and translation possibility checking unit 21 checks whether the multilingual interpretation and translation apparatus 110 of the user is connected with the multilingual interpretation and translation apparatus 120 of the other party to be able to accomplish a communication. In order to communicate with the multilingual interpretation and translation apparatus 120 of the other party, the interpretation and translation possibility checking unit 21 may use a communication device (not shown) such as a modem for short range wireless communication (e.g., Bluetooth, ZigBee, NFC, and the like), Internet communication, mobile communication, or WAVE communication.

The interpretation and translation language checking unit 22 may exchange a message for checking an interpretation and translation language with the multilingual interpretation and translation apparatus 120 of the other party through a communication device (not shown) according to a certain transmission and reception algorithm. The interpretation and translation language checking unit 22 may generate a communicable language list for communicating with the other party according to the message from the multilingual interpretation and translation apparatus 120 of the other party. The interpretation and translation language checking unit 22 may control the output unit 116 to output a communicable language list on a display screen. Similarly, the interpretation and translation language checking unit 22 may provide a message including the communicable language list according to a request from the multilingual interpretation and translation apparatus 120 of the other party.

For example, the language list communicable with the other party includes a use language (e.g., B) of the other party, and may include various translation target language selection options such as an option for selecting a language (e.g., A) which can be translated to the use language (e.g., B) of the other party as a translation target language or an option for selecting an intermediary language (e.g., C, D) as the translation target language as illustrated in a following table. That is, the language list communicable with the other party includes all possible lists including the cases such as whether it is possible to use a translator of the use language (e.g., B) of the other party (hereinafter referred to as ‘direct translation method’) (option 1), whether it is possible to use a translator which can translate into the same intermediary language as that of the other party (hereinafter referred to ‘intermediary method’) (option 2), whether it is possible to use an intermediary translator which can translate into the use language (e.g., B) of the other party (hereinafter referred to as ‘double translation method’) (option 3), and whether it is possible to use an intermediary language which can be translated by passing through another intermediary translator (hereinafter referred to as ‘double translation intermediary method’) (option 4). Since the intermediary language translation method (option 2: A [symbol] C, option 3: ACB, option 4: ACD) may achieve a better performance than the direct translation method (option 1:AB), the interpretation and translation language checking unit 22 outputs all possible lists.

TABLE

| Use language of | | |
|---|---|---|
| the other party | B | |
| Option 1 | A [symbol] B | A to B when transmitting, B to A |
| | | when receiving (A to B when |
| | | transmitting, None is possible |
| | | when receiving) |
| Option 2 | A [symbol] C | A to C when transmitting, |
| | | C to A when receiving |
| Option 3 | A [symbol] C [symbol] B | A to C and then C to B |
| | | when transmitting, B to C and then |
| | | C to A when receiving |
| Option 4 | A [symbol] C [symbol] D | A to C and then C to D when |
| | | transmitting, B to D and then |
| | | D to A when receiving |
| . | . | . |
| . | . | . |

The automatic interpretation and translation language setting unit 23 checks the use language (e.g., A) of the user which is previously set in the multilingual interpretation and translation apparatus 110 of the user, checks the use language (e.g., B) of the other party from the language list communicable with the other party, checks whether a translator communicable with the other party, suitable for the languages (e.g., A, B), is installed therein, and then, automatically selects and sets a translation target language to perform a translation procedure of one step or multiple steps, that is, a target language for the other party which enables to communicate with the other party based on the checked information.

For example, the automatic interpretation and translation language setting unit 23 checks the use language (e.g., A) of the user and the use language (e.g., B) of the other party, and 1) in the case of selecting and setting a translation target language of a first option (direct translation method) when checking the presence of a translator into the use language (e.g, B) of the other, the user inputs a voice or a text of the use language (e.g., A) and translates the voice or the text of the use language (e.g., A) into the use language (e.g., B) of the other party through the multilingual interpretation and translation apparatus 110 of the user to transmit the translated voice or text to the multilingual interpretation and translation apparatus 120 of the other party. In addition, the other party may input a voice or a text of the use language (e.g., B) to transmit (in a case of directly transmitting) the input voice or text to the multilingual interpretation and translation apparatus 120 of the other party through the multilingual interpretation and translation apparatus 110 of the user, or may translate the voice or the text of the use language (e.g., B) into the use language (e.g., A) to transmit (in a case of translating and transmitting) the translated voice or text to the multilingual interpretation and translation apparatus 110 of the user.

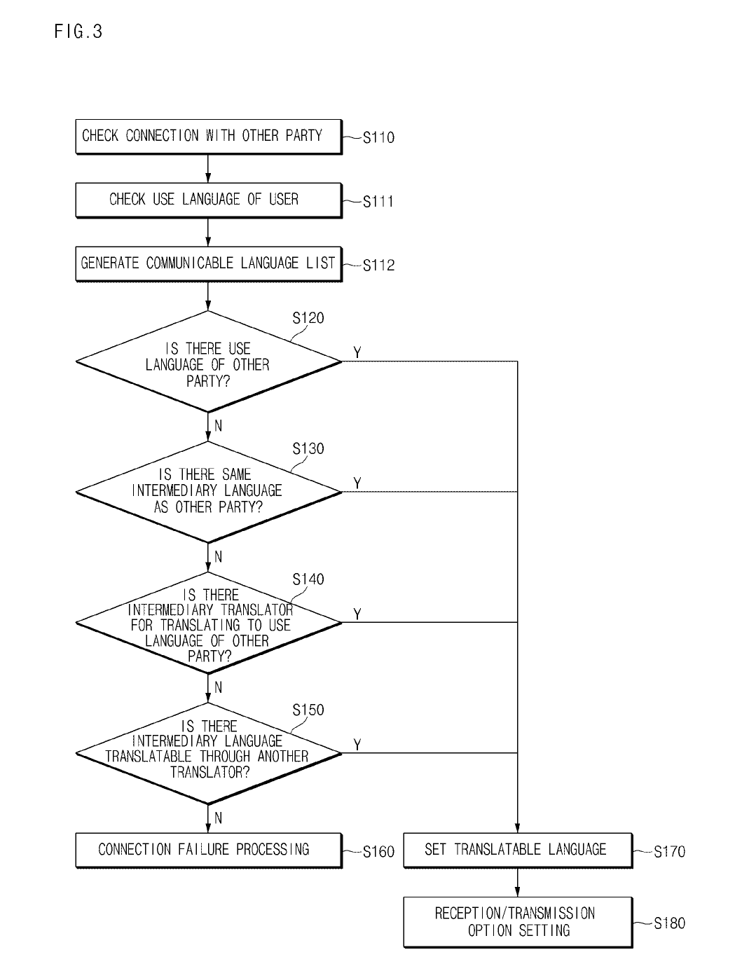

Moreover, 2) a case of selecting and setting a translation target language of a second option (intermediary method), 3) a case of selecting and setting a translation target language of a third option (double translation method), and 4) a case of selecting and setting a translation target language of a fourth option (double translation intermediary method), accomplished by the automatic interpretation and translation language setting unit 23, are described in detail with reference to FIG. 3.

In addition, the automatic interpretation and translation language setting unit 23 may select and set a corresponding translation target language (a target language of one step or multiple steps) according to a language which can be translated by a corresponding translator in the higher order of translation performance based on a certain setting reference among the options of a communicable language list.

As expressed in a following Equation 1, the setting reference SET may be calculated based on information such as the translation ratio P of a use language of the user to a target language by the multilingual interpretation and translation apparatus 110 of the user, the translation rate Q of a use language of the other party to the target language by the multilingual interpretation and translation apparatus 120 of the other party, the word order coidentity determination information R between the use language of the user and a target language in the multilingual interpretation and translation apparatus 110 of the user, the word order coidentity determination information S between the use language of the other party and the target language in the multilingual interpretation and translation apparatus 120 of the other party, a language family distance X between the use language of the user and the target language in the user side, a language family distance Y between the use language of the other party and the target language in the other party side, and a user preference T. As expressed in Equation 1, weights α, β, γ, δ (α+β+γ+δ=1) may be suitably applied and used according to importance of the above information.

SET=PQα+(R+S)β+(X+Y)γ+Tδ [Equation 1]

Basic information P, Q, R, S, X, Y for calculating the above setting reference SET may be stored and used in a storage device such as a memory in the form of a look-up table. Moreover, the user preference E is a value by reflecting a statistical result with respect to translation target languages selected by automatic setting of the automatic interpretation and translation language setting unit 23. The automatic interpretation and translation language setting unit 23 may select and set a translation target language having a high selection frequency according to the statistical result.

For example, when a first case where the translation rate P is 90 and the translation rate Q is 70 is compared with a second case where the translation rate P is 80 and the translation rate Q is 80, the sum, which is 160, of the translation rate P and the translation rate Q of the first case is identical with the sum, which is 160, of the translation rate P and the translation rate Q of the second case, but mutual understanding may be high when the translation rate Q is higher than the translation rate P. Accordingly, as expressed in Equation 1, the first case and the second case have the translation performance of 63% and 64% by applying a multiplication value of the P and the Q so that the second case has a higher translation performance.

For example, in the case of setting the first option (direct translation method), the translation rate of the user P becomes a translation rate of A->B. When the multilingual interpretation and translation apparatus 110 of the user has a translator of B->A and the translation rate Q of B->A in the multilingual interpretation and translation apparatus 120 of the other party is higher, the B->A translation of the multilingual interpretation and translation apparatus 110 of the user may be disregarded. On the other hand, when the translation rate Q of B->A of the other party is lower, the B->A translator of the multilingual interpretation and translation apparatus 110 of the user is used. When the translation rate P of the user is identical with the translation rate Q of the other party, the automatic interpretation and translation language setting unit 23 may control to set the use of the B->A translator of the other party.

In addition, for example, in the case of setting the second option (intermediary method), when translation of the user is A<->C and the translation of the other party is C<->B, the translation rate P of the user is expressed by a following Equation 2. That is, when the translation rate of A->C is 90 and the translation rate of C->A is 80, the translation performance is 85%.

Translation rate P of user=(translation rate of A->C+translation rate of C->A)/2 [Equation 2]

Further, for example, in the case of the fourth option (double translation intermediary method), when the translation of the user is A<->C<->D language and the translation of the other party is D<->B, the translation rate of the user is expressed by a following Equation 3.

Translation rate P of user={(translation rate of A->C)×(translation rate of C->D)+(translation rate of D->C)×(translation rate of C->A)}/2 [Equation 3]

Meanwhile, the word order coidentity determination information R and S in Equation 1 are classified to have −1 or 1. For example, when the word orders are the same (e.g., Korean language->English language), the word order coidentity determination information R, S has a value −1. When the word orders are not the same, the word order coidentity determination information R, S has a value 1. When the word orders are the same, a more natural sentence is generated so that a performance felt by user is increased even if the translation rate is the same. General word order information is as follows.

SVO type (subject-predicate-objective): English language, Chinese language, French language, . . .

SOV type (subject-objective-predicate): Korean language, Japanese language, Turkish language, . . .

VSO type (predicate-subject-objective): Arabic language, Hebrew language, . . .

In addition, in Equation 1, a language family distance X between the use language of the user and the (translation) target language in the user side and a language family distance Y between the use language of the other party and the target language in the other party side mean a distance between respective languages in a language family which is classified into people, branch, group, language, and the like as follows.

Example 1) Chinese: Chinese-Tibet people, Chinese branch, Chinese language

Example 2) English: Indo-European people, Germanic language branch, West German language group, English language

Example 3) German: Indo-European people, German language branch, West German language group, German language

As described above, the language family is added to more easily achieve a relative translation, because the word orders are the same when the language families are the same, but when the sub-families such as people, branch, group, language, and the like of the language family are subdivided and changed, the characteristic of the language is reflected. In the above example, since the language family distance X/Y between English language and Germany language is more closer than the language family distance between Chinese language and English language, when a translation target language such as an intermediary language is selected, the distance of the language family may be additionally considered.

Meanwhile, when the translation performances into the target language with respect to a plurality of options are identical with each other, in order to set the translation target language in the higher order of the translation performance based on the setting reference SET expressed by Equation 1, the automatic interpretation and translation language setting unit 23 may set the translation target language according to a corresponding method by deciding the setting order in the order of the direction translation method, the intermediary method, the double translation method, the double translation intermediary method, and other multiple translation (intermediary) method.

In addition, for example, even if there is no direct translation method and intermediary method, when the setting reference SET are the same with respect to target languages for applying the double translation method, a certain language order of the world may be applied. For example, a translation target language may be set by applying a language order of a certain list (e.g., site http://www.ethnologue.com/statistics/size) classifying a language order of the world based on the number of language users.

As described above, when the translation target language is selected, the controller 111 sets reception/transmission option with respect to the input unit 113, the transmitting unit 114, the receiving unit 115, and the output unit 116, and performs an overall control of the functions such as the transmission of a result of the translation into the translation target language, the reception and translation of response data from the multilingual interpretation and translation apparatus 120 of the other party, and the output, with respect to the input of voices or texts.

As the automatic interpretation and translation language setting unit 23 sets a translation target language having the highest translation performance based on the setting reference expressed by Equation 1, the controller 111 may set reception/transmission option so that the corresponding translator is used for reception/transmission.

For example, like the setting of the second option (intermediary method), if the same intermediary language C as that of the other party is set, setting is accomplished in such a manner that the reception/transmission is achieved in the state where transmission: A->C, reception: C, translation: C->A. This setting method corresponds to a situation where the user has an interpretation and translation device of A language which is a language of the user<->C language, and the other party has an interpretation and translation device of B language which is a language of the other party<->C language.

Further, for example, like the setting of the third option (double translation method), if an intermediary translator which can translate into a language B of the other party is set, the setting is accomplished in such a manner that the reception/transmission and the translation are achieved in the state where transmission: A->C->B translation, reception: B, and translation: B->C->A. This setting method corresponds to a situation where the translation is set between A language which is a language of the user<->C language<->B language in the user side, and the translator of the other party is not used.

In addition, for example, like the method of setting the fourth option (double translation intermediary method), if an intermediary language which can be translated by passing through another intermediary translator is set, the setting is accomplished in such a manner that the reception/transmission and the translation are achieved in the state where transmission: A->C->D, reception: D, and translation: D->C->A. This setting method corresponds to a situation where the user side has a translator of A language which is a language of the user<->C language and a translator of C language<->D language, and the other party has a translator of A language<->D language.

The input unit 113 reads input information of voices or texts which are configured by a use language (e.g., A) of the user input from the user.

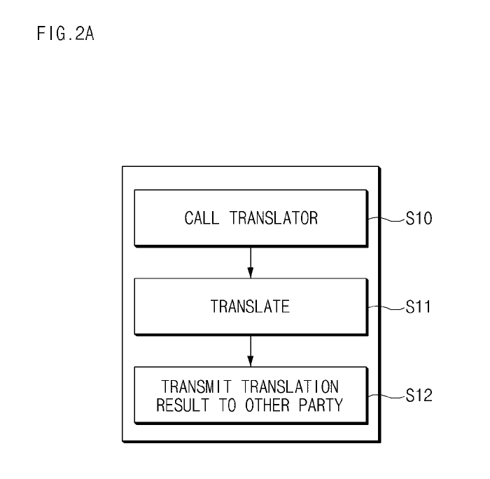

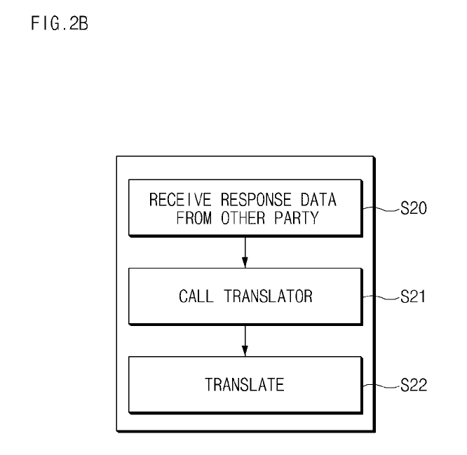

The transmitting unit 114 may select and call (see S10 of FIG. 2A) a translator translating into a corresponding translation target language from among a plurality of translators (not shown), may be able to translate the input text into the translation target language (see S11 of FIG. 2A), and may convert an input voice into a text using a voice recognition device to translate the text into the translation target language using the called translator. The transmitting unit 114 transmits the translation result to the multilingual interpretation and translation apparatus 120 of the other party through a communication device (not shown) (see S12 of FIG. 2A). In this case, translation result data in the form of the voice or the text may be transmitted with respect to the input voice, and the translation result data in the form of the voice or the text may be transmitted with respect to the input text.

The receiving unit 115 may receive response data (translation result) from the multilingual interpretation and translation apparatus 120 of the other party (see S20 of FIG. 2B), and may display a response result of the other party received through the output unit 116 as a text through a display screen or output the response result of the other party as a voice through a speaker. In this case, if necessary (in the case of the multiple-step translation which is described later), the receiving unit 115 may select and call (see S21 of FIG. 2B) a translator translating into a corresponding reverse translation target language from among a plurality of translators (not shown) provided in the apparatus, and receive a response from the other party by translating into the reverse translation target language (see S22 of FIG. 2B). In this case, the reverse translation corresponds to a procedure of translating the response data (translation result) from the multilingual interpretation and translation apparatus 120 of the other party into the use language (e.g., A) of the user. A single translator may perform the translation into the translation target language and the translation into the reverse translation target language according to the mode setting.

FIG. 3 is a flowchart illustrating an operation of the multilingual interpretation and translation apparatus 110 and 120 according to an embodiment of the present disclosure.

First, the user may face the other party within a near distance, or the user may be located away from the other party. The multilingual interpretation and translation apparatus 110 of the user and the multilingual interpretation and translation apparatus 120 of the other party may check whether the multilingual interpretation and translation apparatus 110 of the user is connected with the multilingual interpretation and translation apparatus 120 of the other party to communicate with each other through each interpretation and translation possibility checking unit 21 (S110). The multilingual interpretation and translation apparatus 110 of the user and the multilingual interpretation and translation apparatus 120 of the other party may be operatively associated with each other through a wired/wireless network for supporting a short range distance wireless communication (e.g., Bluetooth, ZigBee, NFC, and the like), wired Internet communication, wireless Internet communication such as wireless fidelity (Wi-Fi) and WiBro, a mobile communication such as WCDMA, LTE, or a Wireless Access in Vehicular Environment (WAVE) wireless communication.

The automatic interpretation and translation language setting unit 23 may check a type of a plurality of translators (not shown) provided in the multilingual interpretation and translation apparatus 110 of the user together with the use language of the user (e.g., A) (S111).

Next, the interpretation and translation language checking unit 22 may generate a language list communicable with the other party according to a message from the multilingual interpretation and translation apparatus 120 of the other party, thereby checking a use language (e.g., B) of the other party from the language list communicable with the other party (S112).

Next, the automatic interpretation and translation language setting unit 23 may check a preset use language A of the user and a use language (e.g., B) of the other party from the language list communicable with the other party, may check whether a translator communicable with the other party suitable for languages (e.g., A, B) is installed therein, and then may automatically select and set a translation target language (target language of one step of multiple steps) for performing the translation procedure of one step of multiple steps, that is, a target language for the other party which enables the user to communicate with the other party.

As the automatic interpretation and translation language setting unit 23 sets a translation target language having the highest translation performance based on the setting reference SET expressed by Equation 1, the controller 111 may control the input unit 113, the transmitting unit 114, the receiving unit 115, and the output unit 116 according to the above reception/transmission option, and perform an overall control of the functions such as the transmission of a result of the translation into the translation target language, the reception and translation of response data from the multilingual interpretation and translation apparatus 120 of the other party, and the output, with respect to the input of voices or texts (S120 to S152).

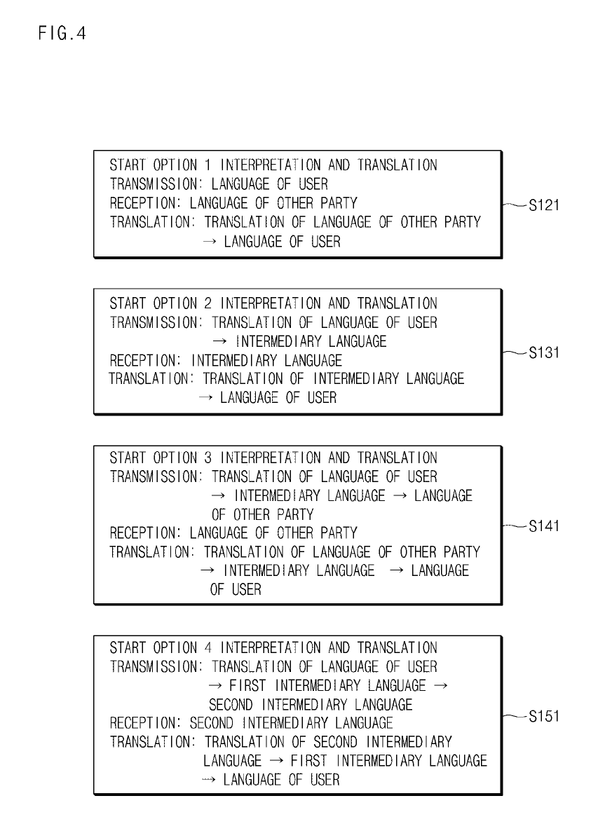

For example, when checking a use language (e.g., A) of the user and the use language (e.g., B) of the other party, checking presence of the translator for translation between the use language (e.g., A) of the user and the use language (e.g., B) of the other party, and checking that the first option (direct translation method) has the highest translation performance based on the setting reference SET (S120), the automatic interpretation and translation language setting unit 23 may select and set a translation target language of the first option (direct translation method) (e.g., A to B when transmitting, B to A when receiving) (S170). According to corresponding reception/transmission option setting, referring to step S121 of FIG. 4, when the user inputs the voice or the text of the use language (e.g., A) through the input unit 113 and translates the use language (e.g., B) of the other party through the transmitting unit 114 to transmit the translated use language (e.g., B) of the other party to the multilingual interpretation and translation apparatus 120 of the other party, and the other party inputs voices or texts of the use language (e.g., B) through the multilingual interpretation and translation apparatus 120 of the other party to transmit the voices or the texts to the multilingual interpretation and translation apparatus 110 of the user, the receiving unit 115 may translate corresponding reception data into the use language of the user to output the translated use language of the user to the output unit 116 (S180).

However, in this case, the multilingual interpretation and translation apparatus 120 of the other party may include a translator for translating a use language (e.g., B) of the other party into the use language of the user (e.g., A). In this case, for example, the translation target language may be selected in such a manner that A to B when transmitting, and None when receiving. In this case, the user may input voices or texts of a use language (e.g., A) through the input unit 113 and translate the input voice or texts into a use language (e.g., B) of the other party to transmit the translated voices or texts in the use language (e.g., B) of the other party to the multilingual interpretation and translation apparatus 120 of the other party through the transmitting unit 114, and the other party may input voices or texts of the use language (e.g., B) and translate the voices or texts to the use language (e.g., A) of the user through the multilingual interpretation and translation apparatus 120 to transmit the translated voices or texts to the multilingual interpretation and translation apparatus 110 of the user. In this case, the receiving unit 115 may output the reception data of the result translated to the use language (e.g., A) of the user to the output unit 116 without the need of the translation.

Further, in some cases, the multilingual interpretation and translation apparatus 120 of the user may not be equipped with a translator for translating the use language (e.g., A) of the user into the use language (e.g., B) of the other party. In this case, the automatic interpretation and translation language setting unit 23 may check the same intermediary language (e.g., C) as that of the other party from the communicable language list (S130). That is, when the multilingual interpretation and translation apparatus 110 of the user includes a translator for translation between the use language (e.g., A) of the user and the intermediary language (e.g., C), and the multilingual interpretation and translation apparatus 120 of the other party includes a translator for translation between the intermediary language (e.g., C) and the use language (e.g., B) of the other party, the automatic interpretation and translation language setting unit 23 may select and set a translation target language (e.g., A to C when transmitting, C to A when receiving), after checking that the second option (intermediary method) has the highest translation performance based on the setting reference SET (S170). According to the corresponding reception/transmission option setting, referring to S131 of FIG. 4, the user may input voices or texts of the use language (e.g., A) through the input unit 113 and translate the voices or texts of the use language (e.g., A) into an intermediary language (e.g., C) to transmit to the multilingual interpretation and translation apparatus 120 of the other party, and, when the other party inputs and translates voices of texts of the use language (e.g., B) into the intermediary language (e.g., C) through the multilingual interpretation and translation apparatus 120 and transmit to the multilingual interpretation and translation apparatus 110 of the user, the receiving unit 115 may translate the reception data of the result translated into the intermediary language (e.g., C) to the use language (e.g., A) of the user to transmit to the output unit 116 (S180).

In addition, when the multilingual interpretation and translation apparatus 120 of the user does not include a translator for directly translating the use language (e.g., A) of the user into the use language (e.g., B) of the other party, the user may not communicate with the other party through the intermediary language (e.g., C). In this case, the automatic interpretation and translation language setting unit 23 may check whether there are a translator for translation between the use language (e.g., A) of the user and the intermediary language (e.g., C) and a translator for translation between the use language (e.g., B) of the other party and the intermediary language (e.g., C) (S140). When there is the translator for a second step translation, the automatic interpretation and translation language setting unit 23 may check that the third option (double translation method) has the highest translation performance based on the setting reference SET, and may select and set a translation target language (A to C and C to B again when transmitting) of the third option (double translation method) (S170).

According to the corresponding reception/transmission option setting, referring to S141 of FIG. 4, the user may input voices or texts of the use language (e.g., A) of the user through the input unit 113 and translate into an intermediary language (e.g., C) through the transmitting unit 114 and translate again the voices or texts of the intermediary language (e.g., C) into the use language (e.g., B) of the other party to transmit to the multilingual interpretation and translation apparatus 120 of the other party. When the other party inputs voices of texts of the use language (e.g., B) through the multilingual interpretation and translation apparatus 120 to transmit to the multilingual interpretation and translation apparatus 110 of the user, the receiving unit 115 may translate the received response data of the use language (e.g., B) of the other party into the intermediary language (e.g., C) and translate again the intermediary language (e.g., C) into the use language (e.g., A) of the user to transmit to the output unit 116 (S180).

In addition, when the multilingual interpretation and translation apparatus 120 of the user does not include a translator for directly translating the use language (e.g., A) of the user into the use language (e.g., B) of the other party, the user cannot communicate with the other party through a first intermediary language (e.g., C). However, if the first intermediary language (e.g., C) is translated into a second intermediary language (e.g., C) and provided, it is possible communicate with each other. In this case, the automatic interpretation and translation language setting unit 23 may check whether there are a translator for translation between the use language (e.g., A) of the user and the first intermediary language (e.g., C) and a translator for translation between the first intermediary language (e.g., C) and the second intermediary language (e.g., D) (S150). When there is the translator for a second step translation, the automatic interpretation and translation language setting unit 23 may select and set a translation target language (A to C and C to D again when transmitting) of the fourth option (double translation intermediary method), after checking that the fourth option (double translation intermediary method) has the highest translation performance based on the setting reference SET (S170).

According to the corresponding reception/transmission option setting, referring to S151 of FIG. 4, the user may input voices or texts of the use language (e.g., A) of the user through the input unit 113 and translate into the first intermediary language (e.g., C) through the transmitting unit 114 and translate again the first intermediary language (e.g., C) into the second intermediary language (e.g., D) to transmit to the multilingual interpretation and translation apparatus 120 of the other party. When the other party may input voices or texts of the use language (e.g., B) and translate into the intermediary language (e.g., D) to transmit to the multilingual interpretation and translation apparatus 110 of the user, the receiving unit 115 may translate the received response data of the second intermediary language (e.g., D) into the first intermediary language (e.g., C) and translate again the first intermediary language (e.g., C) into the use language (e.g., A) of the user to transmit to the output unit 116 (S180).

In addition to the above described examples, those skilled in the art may use other modified method to automatically select the translation target language based on the above examples. When a language communicable with the other party is not searched from the language list communicable with the other party, the automatic interpretation and translation language setting unit 23 may transmit a certain message on a connection failure to the multilingual interpretation and translation apparatus 120 of the other party (S160).

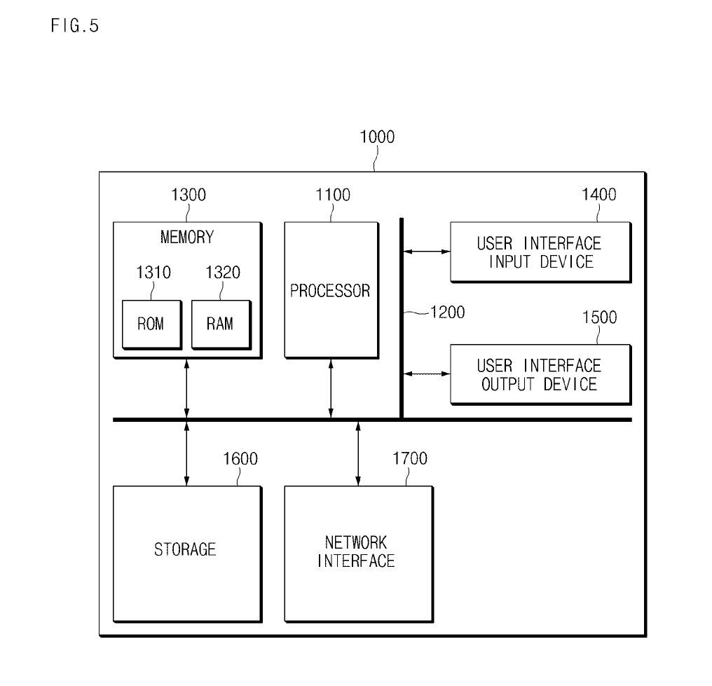

FIG. 5 is a block diagram illustrating an example of the multilingual interpretation and translation apparatus 110/120 according to an embodiment of the present disclosure.

The multilingual interpretation and translation apparatus 110/120 according to an embodiment of the present disclosure may be implemented by a hardware, a software module, or a combination thereof. For example, the multilingual interpretation and translation apparatus 110/120 may be implemented by a computing system 1000 as shown in FIG. 5.

The computing system 1000 may include at least one processor 1100 which is connected via a bus 1200, memory 1300, an user interface input device 1400, an user interface output device 1500, a storage 1600, and a network interface 1700. The processor 1100 may be a semiconductor device for performing a processing for instructions stored in a central processing unit (CPU) or the memory 1300 and/or the storage 1600. The memory 1300 and the storage 1600 may include various types of volatile and nonvolatile storage media. For example, the memory 1300 may include a Read Only Memory (ROM) 1310 and a Random Access Memory (RAM) 1320.

Thus, the steps of the method or the algorithm described in association with the embodiments disclosed herein may be directly implemented by a hardware, a software module, or a combination of the two executed by the processor 1100. The software module may reside in a storage medium (i.e., in the memory 1300 and/or the storage 1600) such as a RAM memory, a flash memory, a ROM memory, an EPROM memory, an EEPROM memory, a register, a hard disk, a removable disk, and CD-ROM. The exemplary storage medium may be coupled to the processor 1100, and the processor 1100 may read information from the storage medium and write information to the storage medium. Alternatively, the storage medium may be integrated in the processor 1100. The processor and the storage medium may reside in an application specific integrated circuit (ASIC). The ASIC may reside in a user terminal. Alternatively, the processor and the storage medium may reside in the user terminal as an individual component.

As described above, the multilingual interpretation and translation apparatus 110/120 according to the present disclosure may perform automatic interpretation and translation into a selected target language with respect to the multilingual voice or text input to provide the result as a voice or a screen, by automatically checking and selecting the target language of the other party from a plurality of options so that the user may communicate with the other party using the message exchanged with the interpretation and translation apparatus of the other party through communication, thereby providing the interpretation and translation service with improved convenience for the user.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for interpretation and translation accomplished by an interpretation and translation apparatus of a user through interfacing with an interpretation and translation apparatus of the other party, the method comprising:
automatically setting a translation target language which enables to communicate with the other party based on a message from the interpretation and translation apparatus of the other party by using a communication connection in a network;
receiving input information of a use language of the user;
calling a translator corresponding to the translation target language to transmit a result obtained by translating the input information into the translation target language to the interpretation and translation apparatus of the other party; and
outputting received data from the interpretation and translation apparatus of the other party or outputting the result obtained by translating the received data into the use language of the user by using the translator.

2. The method of claim 1, wherein the input information comprises a voice or a text.

3. The method of claim 1, wherein automatically setting a translation target language comprises:
checking whether a communication with the interpretation and translation apparatus of the other party is connected;
generating a language list communicable with the other party according to the message; and
setting the translation target language by checking whether a translator, which is suitable for corresponding languages, communicable with the other party is installed therein, according to a preset use language of the user and a use language of the other party checked from the communicable language list.

4. The method of claim 3, wherein setting the translation target language comprises setting the translation target language in the communicable language list in a higher order of a translation performance based on a setting reference, and
the setting reference is based on information comprising a translation rate of the use language of the user to a target language, a translation rate of the use language of the other party to the target language in the interpretation and translation apparatus of the other party, word order coidentity between the use language of the user and the target language, word order coidentity between the use language of the other party and the target language in the interpretation and translation apparatus of the other party, a language family distance between the use language of the user and the target language in a user side, a language family distance between the use language of the other party and the target language in the other party side, and a user preference.

5. The method of claim 1, wherein automatically setting a translation target language comprises setting the translation target language according to a preset order of a plurality of translation methods or setting the translation target language according to a preset order of world languages, among options that have the same translation performance into a target language according to a certain setting reference in the communicable language list.

6. The method of claim 1, wherein automatically setting a translation target language comprises:
selecting the translation target language to use a translator between the use language of the user and the use language of the other party,
translating the input information of the use language of the user into the use language of the other party to transmit to the interpretation and translation apparatus of the other party, by using the translator, and translating and outputting received data of the use language of the other party from the interpretation and translation apparatus of the other party into the use language of the user or outputting received data of the use language of the user from the interpretation and translation apparatus of the other party without translation.

7. The method of claim 1, wherein automatically setting a translation target language comprises:
selecting the translation target language to use a translator between the use language of the user and an intermediary language,
translating the input information of the use language of the user into the intermediary language to transmit to the interpretation and translation apparatus of the other party, by using the translator, and translating and outputting received data of the intermediary language from the interpretation and translation apparatus of the other party into the use language of the user.

8. The method of claim 1, wherein automatically setting a translation target language comprises:
selecting the translation target language to use a first translator between the use language of the user and an intermediary language and a second translator between the intermediary language and the use language of the other party,
sequentially performing translation of the input information of the use language of the user into the intermediary language and translation of the input information into the use language of the other party to transmit to the interpretation and translation apparatus of the other party, by using the first translator and the second translator, and sequentially performing translation of received data of the use language of the other party from the interpretation and translation apparatus of the other party into the intermediary language and translation of received data into the use language of the user to output the translated received data.

9. The method of claim 1, wherein automatically setting a translation target language comprises:
selecting the translation target language to use a first translator between the use language of the user and a first intermediary language and a second translator between the first intermediary language and a second intermediary language, sequentially performing translation of the input information of the use language of the user into the first intermediary language and translation of the input information into the second intermediary language to transmit to the interpretation and translation apparatus of the other party, by using the first translator and the second translator, and sequentially performing translation of received data of the second intermediary language from the interpretation and translation apparatus of the other party into the first intermediary language and translation of received data into the use language of the user to output the translated received data.

10. An interpretation and translation apparatus of a user through interfacing with an interpretation and translation apparatus of the other party, the apparatus comprising:
an interpretation and translation interface configured to automatically set a translation target language which enables to communicate with the other party based on a message from the interpretation and translation apparatus of the other party by using a communication connection in a network;
an input unit configured to receive input information of a use language of the user;
a transmitting unit configured to call a translator corresponding to the translation target language to transmit a result obtained by translating the input information into the translation target language to the interpretation and translation apparatus of the other party; and
a reception unit configured to output received data from the interpretation and translation apparatus of the other party or output the result obtained by translating the received data into the use language of the user by using the translator.

11. The apparatus of claim 10, wherein the input information comprises a voice or a text.

12. The apparatus of claim 10, wherein the interpretation and translation interface comprises:
an interpretation and translation possibility checking unit configured to check whether a communication with the interpretation and translation apparatus of the other party is connected;
an interpretation and translation language checking unit configured to generate a language list communicable with the other party according to the message; and
an automatic interpretation and translation language setting unit configured to set the translation target language by checking whether a translator, which is suitable for corresponding languages, communicable with the other party is installed therein, according to a preset use language of the user and a use language of the other party checked from the communicable language list.

13. The apparatus of claim 12, wherein the automatic interpretation and translation language setting unit sets the translation target language in the communicable language list in a higher order of a translation performance based on a setting reference, and
the setting reference is based on information comprising a translation rate of the use language of the user to a target language, a translation rate of the use language of the other party to the target language in the interpretation and translation apparatus of the other party, word order coidentity between the use language of the user and the target language, word order coidentity between the use language of the other party and the target language in the interpretation and translation apparatus of the other party, a language family distance between the use language of the user and the target language in a user side, a language family distance between the use language of the other party and the target language in the other party side, and a user preference.

14. The apparatus of claim 10, wherein the automatic interpretation and translation language setting unit sets the translation target language according to a preset order of a plurality of translation methods or setting the translation target language according to a preset order of world languages, among options that have the same translation performance into a target language according to a certain setting reference in the communicable language list.

15. The apparatus of claim 10, wherein the interpretation and translation interface selects the translation target language to use a translator between the use language of the user and the use language of the other party, translates the input information of the use language of the user into the use language of the other party to transmit to the interpretation and translation apparatus of the other party, by using the translator, and translates and outputs received data of the use language of the other party from the interpretation and translation apparatus of the other party into the use language of the user or outputs received data of the use language of the user from the interpretation and translation apparatus of the other party without translation.

16. The apparatus of claim 10, wherein the interpretation and translation interface selects the translation target language to use a translator between the use language of the user and an intermediary language, translates the input information of the use language of the user into the intermediary language to transmit to the interpretation and translation apparatus of the other party, by using the translator, and translates and outputs received data of the intermediary language from the interpretation and translation apparatus of the other party into the use language of the user.

17. The apparatus of claim 10, wherein the interpretation and translation interface selects the translation target language to use a first translator between the use language of the user and an intermediary language and a second translator between the intermediary language and the use language of the other party, sequentially performs translation of the input information of the use language of the user into the intermediary language and translation of the input information into the use language of the other party to transmit to the interpretation and translation apparatus of the other party, by using the first translator and the second translator, and sequentially performs translation of received data of the use language of the other party from the interpretation and translation apparatus of the other party into the intermediary language and translation of received data into the use language of the user to output the translated received data.

18. The apparatus of claim 10, wherein the interpretation and translation interface selects the translation target language to use a first translator between the use language of the user and a first intermediary language and a second translator between the first intermediary language and a second intermediary language, sequentially performs translation of the input information of the use language of the user into the first intermediary language and translation of the input information into the second intermediary language to transmit to the interpretation and translation apparatus of the other party, by using the first translator and the second translator, and sequentially performs translation of received data of the second intermediary language from the interpretation and translation apparatus of the other party into the first intermediary language and translation of received data into the use language of the user to output the translated received data.
